(19) United States
(12) Patent Application Publication
(10) Pub. No.: US 2026/0179519 A1
(43) Pub. Date: Jun. 25, 2026

(54) SOURCE DRIVER, DISPLAY DEVICE INCLUDING THE SAME, AND OPERATING METHOD OF SOURCE DRIVER

(71) Applicant: Samsung Electronics Co., Ltd., Suwon-si (KR)

(72) Inventors: Donghan Lee, Suwon-si (KR); Sanghyeon Lee, Suwon-si (KR); Jiyong Jeong, Suwon-si (KR)

(21) Appl. No.: 19/411,577

(22) Filed: Dec. 8, 2025

(30) Foreign Application Priority Data
Dec. 19, 2024 (KR) 10-2024-0191704

(51) Int. Cl. G09G 3/20

(52) U.S. Cl. CPC G09G 3/2007; G09G 2310/027; G09G 2310/0291; G09G 2320/0252; G09G 2340/0407

(57) ABSTRACT

A source driver includes driving channels, wherein each of the driving channels includes an output buffer circuit including a first output buffer and a second output buffer, a decoder circuit including a first decoder configured to generate a first grayscale voltage based on N bits of pixel data and a second decoder configured to generate a second grayscale voltage based on M bits of the pixel data, where N is an integer of equal to or greater than 2 and M is greater than N, an input switch circuit configured to provide one of the first and second grayscale voltages to the first output buffer and the other one of the first and second grayscale voltages to the second output buffer, and an output switch circuit configured to output one of output signals of the first and second output buffers to a source line of a display panel.

### CROSS-REFERENCE TO RELATED APPLICATION

This application is based on and claims priority under 35 U.S.C. §119 to Korean Patent Application No. 10-2024-0191704, filed on December 19, 2024, in the Korean Intellectual Property Office, the disclosure of which is incorporated by reference herein in its entirety.

### BACKGROUND

The inventive concept relates to a semiconductor circuit, and more particularly, to a source driver providing pixel signals to a display panel, a display device including the source driver, and an operating method of the source driver.

A display device includes a display panel displaying an image and a display driver circuit driving the display panel. The display driver circuit may receive image data from an external host and may drive the display panel by applying pixel voltages corresponding to the image data to the display panel through a plurality of source lines of the display panel. As the resolution or frame rate of the display panel increases, a horizontal period that is allocated to drive a single row of the display panel decreases. Accordingly, a source line needs to be charged to a particular voltage (e.g., a pixel voltage corresponding to pixel data) within a limited time. There has been research into a display driver circuit capable of decreasing the time taken for a display load to be charged to a pixel voltage, e.g., a settling time taken for a source line to settle at the pixel voltage.

### SUMMARY

Aspects of the inventive concept provide a source driver capable of minimizing an increase in circuit size and increasing the load charge rate of a display panel, a display device including the source driver, and an operation method of the source driver.

According to an aspect of the inventive concept, a source driver includes a plurality of driving channels, each configured to receive pixel data, generate an image signal based on the pixel data, and provide the image signal to a source line among a plurality of source lines of a display panel, wherein each of the plurality of driving channels includes an output buffer circuit including a first output buffer and a second output buffer, a decoder circuit including a first decoder configured to generate a first grayscale voltage based on N bits of the pixel data and a second decoder configured to generate a second grayscale voltage based on M bits of the pixel data, where M and N are natural numbers equal to or greater than 2, and M is greater than N, an input switch circuit configured to provide one of the first grayscale voltage and the second grayscale voltage to the first output buffer and the other one of the first grayscale voltage and the second grayscale voltage to the second output buffer; and an output switch circuit configured to output, as the image signal, one of a first output signal of the first output buffer and a second output signal of the second output buffer to the source line of the display panel.

According to another aspect of the inventive concept, there is provided an operating method of a source driver. The operating method includes precharging a first output buffer based on an (n+1)-th coarse grayscale voltage output from a first decoder in an n-th horizontal period, where "n" is a natural number, outputting, by a second output buffer, a first output voltage to a source line of a display panel in the n-th horizontal period, the first output voltage being generated based on an n-th fine grayscale voltage output from a second decoder, outputting, by the first output buffer, a second output voltage to the source line in an (n+1)-th horizontal period, the second output voltage being generated based on an (n+1)-th fine grayscale voltage output from the second decoder, and precharging the second output buffer based on an (n+2)-th coarse grayscale voltage in the (n+1)-th horizontal period, the (n+2)-th coarse grayscale voltage being received from the first decoder, wherein a resolution of the first decoder is lower than a resolution of the second decoder.

According to a further aspect of the inventive concept, a display device includes a plurality of pixels at intersections of a plurality of gate lines and a plurality of source lines, each pixel of the plurality of pixels being connected to a corresponding gate line among the plurality of gate lines and to a corresponding source line among the plurality of source lines, a gate driver connected to the plurality of gate lines and configured to provide one of gate-on voltage and gate-off voltage to each of the plurality of gate lines, and a source driver connected to the plurality of source lines, wherein the source driver includes a plurality of driving channels, each of the plurality of driving channels configured to receive pixel data, and provide an image signal corresponding to the pixel data to a source line among the plurality of source lines, wherein each of the plurality of driving channels includes a decoder circuit including a first decoder configured to generate coarse grayscale voltages and a second decoder configured to generate fine grayscale voltages, each of the coarse grayscale voltages is generated from N bits of the corresponding pixel data, and each of the fine grayscale voltages is generated from M bits of the corresponding pixel data, where M and N are natural numbers equal to or greater than 2, and M is greater than N, and an output buffer circuit including a first output buffer and a second output buffer, the first output buffer and the second output buffer configured to be alternately precharged based on the coarse grayscale voltages and being configured to alternately drive the source line based on the fine grayscale voltages.

### BRIEF DESCRIPTION OF THE DRAWINGS

Embodiments will be more clearly understood from the following detailed description taken in conjunction with the accompanying drawings in which:

FIG. 1 is a block diagram of a display device according to an embodiment;

FIG. 2 illustrates a source driver according to an embodiment;

FIGS. 3A and 3B illustrate operations of a driving channel according to an embodiment;

FIG. 4 illustrates output voltages of a driving channel, according to an embodiment;

FIG. 5 illustrates output voltages of an output buffer, according to an embodiment and comparative examples;

FIG. 6 illustrates data received by a driving channel and outputs generated based on the data, according to an embodiment;

FIG. 7 is a timing diagram illustrating an operating method of a driving channel, according to an embodiment;

FIGS. 8A to 8C illustrate operations of a driving channel, according to an embodiment;

FIGS. 9A and 9B are timing diagrams of a driving channel according to an embodiment;

FIG. 10 is a timing diagram of a driving channel according to an embodiment;

FIGS. 11A and 11B illustrate operations of a driving channel, according to an embodiment;

FIG. 12 illustrates a logic circuit according to an embodiment;

FIG. 13 is a flowchart of an operating method of a source driver, according to an embodiment;

FIG. 14 illustrates an example implementation of a display device according to an embodiment;

FIG. 15 illustrates an example implementation of a display device according to an embodiment; and

FIG. 16 illustrates an electronic device including a display device, according to an embodiment.

### DETAILED DESCRIPTION OF THE EMBODIMENTS

Hereinafter, embodiments are described in detail with reference to the accompanying drawings.

Throughout the specification, when a component is described as "including" a particular element or group of elements, it is to be understood that the component is formed of only the element or the group of elements, or the element or group of elements may be combined with additional elements to form the component, unless the context indicates otherwise.

Items described in the singular herein may be provided in plural. Thus, the description of a single item that is provided in plural should be understood to be applicable to the remaining plurality of items unless context indicates otherwise. For example, “pixel data” may be a data corresponding to a pixel, or may be a data corresponding to a plurality of pixels.

It will be understood that, although the terms first, second, third etc. may be used herein to describe various elements or components, these elements or components should not be limited by these terms. Unless the context indicates otherwise, these terms are only used to distinguish one element or component from another element or component. Thus, a first element or component discussed below in one section of the specification could be termed as a second element or component in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

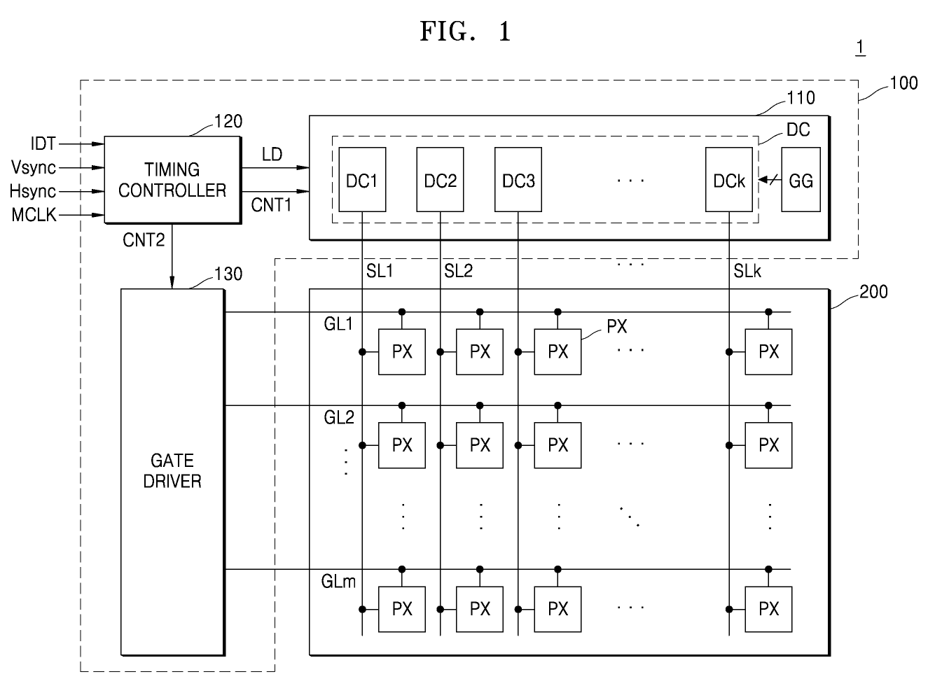

FIG. 1 is a block diagram of a display device according to an embodiment.

According to an embodiment, a display device 1 may be mounted on an electronic device having an image display function. For example, the electronic device may include a television, a smartphone, a tablet personal computer (PC), a portable multimedia player (PMP), a camera, a wearable device, a digital video disk (DVD) player, a refrigerator, an air conditioner, a set-top box, a robot, a drone, a medical device, a navigation device, a global positioning system (GPS) receiver, a vehicle device, furniture, or measuring equipment.

Referring to FIG. 1, the display device 1 may include a display panel 200 displaying an image and a display driver circuit 100 (or referred to as a display driver integrated circuit) driving the display panel 200.

In an embodiment, the display driver circuit 100 and the display panel 200 may be implemented as a single module. For example, the display driver circuit 100 may be mounted on a substrate of the display panel 200 or may be electrically connected to the display panel 200 through a connecting member, such as a flexible printed circuit board (FPCB).

The display panel 200 actually displays an image and may include a display, such as an organic light-emitting diode (OLED) display, a thin film transistor-liquid crystal display (TFT-LCD), a field emission display, or a plasma display panel (PDP), which receives an electrically transmitted image signal and displays a two-dimensional (2D) image.

The display panel 200 may include a plurality of gate lines GL1 to GLm (where "m" is an integer of at least 2), a plurality of source lines SL1 to SLk each crossing the gate lines GL1 to GLm (where "k" is an integer of at least 2), and a plurality of pixels PX, each located in a region where the gate lines GL1 to GLm intersect with the source lines SL1 to SLk.

Each of the pixels PX may include a light-emitting element and may emit predetermined color of light. Each of the pixels PX may emit light, and light intensity may correspond to a grayscale indicated by pixel signals (or image signals) provided through a source line corresponding to each pixel PX among the source lines SL1 to SLk.

Among the pixels PX, at least two pixels PX (e.g., red, blue, and green pixels), which are adjacent to each other in one line or in adjacent lines and respectively output different colors of light, may form a single pixel unit. The at least two pixels PX forming a pixel unit may be referred to as sub-pixels. In an embodiment, the display panel 200 may have an RGB structure in which red, green, and blue pixels form a single pixel unit. However, embodiments are not limited thereto, and the display panel 200 may have an RGBW structure, in which a pixel unit further includes a white pixel for luminance enhancement, or an RGBG structure (or referred to as a pentile structure), in which a pixel unit includes one red pixel, one blue pixel, and two green pixels. Alternatively, a pixel unit of the display panel 200 may include pixels of other colors than red, green, and blue.

The display driver circuit 100 may include a timing controller 120, a source driver 110, and a gate driver 130. The display driver circuit 100 may further include other components, for example, an interface circuit receiving image data IDT and control signals, a voltage generation circuit generating voltages used in the display driver circuit 100, and an image processing circuit for image processing of the image data IDT.

In an embodiment, the timing controller 120, the source driver 110, and the gate driver 130 may be formed in at least one semiconductor chip. In an embodiment, the timing controller 120 and the source driver 110 may be formed in at least one semiconductor chip, and the gate driver 130 may be formed in the display panel 200.

The timing controller 120 may generally control operations of the display driver circuit 100 and may control the components, e.g., the source driver 110 and the gate driver 130, of the display driver circuit 100 to display the image data IDT on the display panel 200.

The timing controller 120 may receive the image data IDT and a control signal from an external processor (e.g., a host processor or an application processor). For example, the control signal may include a vertical synchronization signal Vsync, a horizontal synchronization signal Hsync, and a master clock signal MCLK. In an embodiment, the timing controller 120 may internally generate the vertical synchronization signal Vsync and the horizontal synchronization signal Hsync, based on the master clock signal MCLK. The vertical synchronization signal Vsync may indicate a frame period during which the image data IDT of a single frame is displayed on the display panel 200, and the horizontal synchronization signal Hsync may indicate a horizontal period during which a single row of the display panel 200 is driven (for example, during which an image signal is provided to a single row of the display panel 200).

The timing controller 120 may convert the format of the image data IDT according to the structure (e.g., RGB structure, RGBW structure, RGBG structure, etc.) of the display panel 200 or may perform image processing of the image data IDT to increase the quality of an image displayed on the display panel 200. The timing controller 120 may output the image data IDT to the source driver 110 in units of line data LD. The line data LD may include multiple pixel data corresponding to pixels PX in a single row of the display panel 200.

The timing controller 120 may generate various control signals for controlling the timings of the source driver 110 and the gate driver 130. The timing controller 120 may output at least one first control signal CNT1 to the source driver 110 and at least one second control signal CNT2 to the gate driver 130.

In an embodiment, the timing controller 120 may be implemented by hardware or a combination of software (or firmware) and hardware. For example, the timing controller 120 may be implemented by a hardware logic, such as an application specific integrated circuit (ASIC), a field programmable gate array (FPGA), or a complex programmable logic device (CPLD), firmware or software, which is run by a processor, such as a micro controller unit (MCU) or a central processing unit (CPU), or a combination of hardware and software.

The source driver 110 may convert the line data LD received from the timing controller 120 into a plurality of pixel signals and provide the pixel signals to the source lines SL1 to SLk.

The gate driver 130 may be connected to the gate lines GL1 to GLm of the display panel 200 and may sequentially select the gate lines GL1 to GLm by sequentially applying a gate-on voltage to the gate lines GL1 to GLm in a single frame period. The single frame period may include a plurality of horizontal periods, and a single gate line may be selected in a single horizontal period. In a single horizontal period, a gate-on voltage may be applied to the selected gate line and a gate-off voltage may be applied to the unselected gate lines.

In an embodiment, a gate-on voltage may be applied to the selected gate line, and each of pixels PX connected to the selected gate line may be electrically connected to its corresponding one of the source lines SL1 to SLk and may receive a pixel signal from its corresponding source line. Thereafter, a gate-off voltage may be applied to the selected gate line, and each of the pixels PX may be electrically disconnected from its corresponding source line.

As described above, the gate driver 130 may sequentially select the gate lines GL1 to GLm in a plurality of horizontal periods of a single frame period. The source driver 110 may provide a pixel signal to each of the source lines SL1 to SLk. Pixels PX connected to the selected gate line may store pixel signals received through the source lines SL1 to SLk and may emit light based on the stored pixel signals, the light having an intensity corresponding to a grayscale indicated by the stored pixel signal in a single frame period. Accordingly, an image corresponding to the image data IDT may be displayed on the display panel 200 in units of frames.

According to an embodiment, the source driver 110 may include a plurality of driving channels DC1 to DCk and a gamma generation circuit GG (or referred to as a grayscale voltage generation circuit). The gamma generation circuit GG may generate a plurality of grayscale voltages corresponding to a plurality of data values represented by pixel data and may provide the plurality of grayscale voltages to each of the driving channels DC1 to DCk.

Each of the driving channels DC1 to DCk may convert pixel data into a pixel signal based on the plurality of grayscale voltages received from the gamma generation circuit GG and drive its corresponding source line among the source lines SL1 to SLk by providing the pixel signal to its corresponding source line.

In an embodiment, as shown in FIG. 1, the number of source lines SL1 to SLk may be the same as the number of driving channels DC1 to DCk. In a single horizontal period, each of the driving channels DC1 to DCk may be connected to one source line and may provide a pixel signal to the connected source line. However, embodiments are not limited thereto. In an embodiment, the number of source lines SL1 to SLk may be greater than the number of driving channels DC1 to DCk, and each of the driving channels DC1 to DCk may be alternately connected to at least two source lines in a time division manner in a single horizontal period and may provide at least two pixel signals to the connected source lines in a time division manner. Hereinafter, it is assumed that the number of source lines SL1 to SLk is the same as the number of driving channels DC1 to DCk.

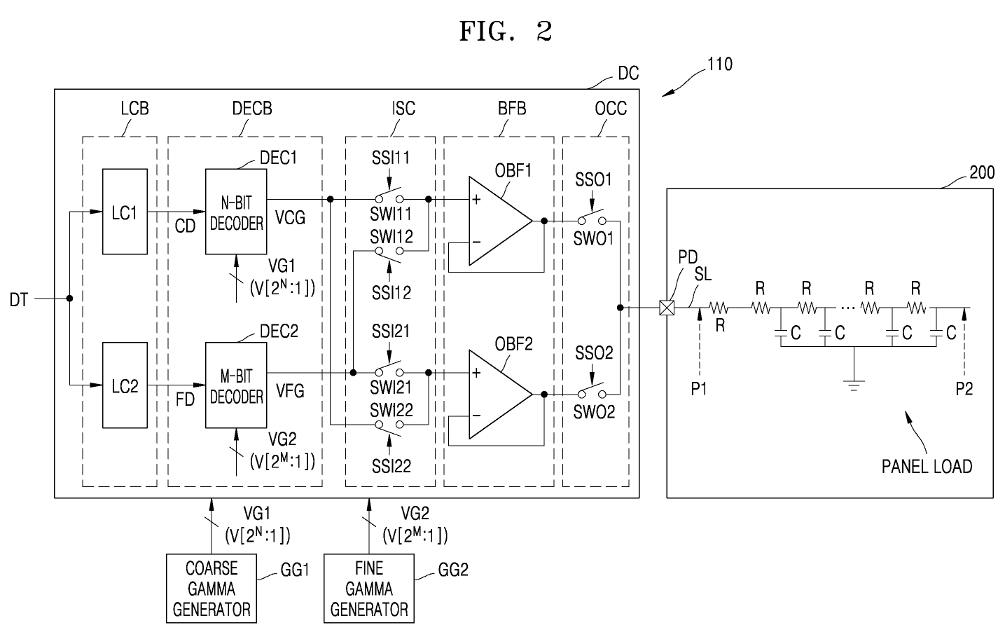

Each of the driving channels DC1 to DCk may include a first decoder DEC1 (in FIG. 2), a second decoder DEC2 (in FIG. 2) having a different resolution than the first decoder DEC1, a first output buffer OBF1 (in FIG. 2), and a second output buffer OBF2 (in FIG. 2) and may drive a source line according to a coarse precharge-fine driving method according to an embodiment.

Pixel data received by each of the driving channels DC1 to DCk may include M bits. The first decoder DEC1 may select one of 2^{N} grayscale voltages as a coarse grayscale voltage (e.g., a first grayscale voltage), based on N bits among the M bits of the pixel data, and the second decoder DEC2 may select one of 2^{M} grayscale voltages as a fine grayscale voltage (e.g., a second grayscale voltage), based on the M bits of the pixel data. Here, N is an integer of at least 2, and M is an integer greater than N. Accordingly, the resolution of the second decoder DEC2 may be greater than the resolution of the first decoder DEC1, and the circuit size of the first decoder DEC1 may be less than the circuit size of the second decoder DEC2.

The first output buffer OBF1 and the second output buffer OBF2 may be alternately and coarsely precharged based on the coarse grayscale voltage provided from the first decoder DEC1 and may alternately drive a source line (for example, alternately provide a pixel signal) based on the fine grayscale voltage provided from the second decoder DEC2. Here, an output buffer may be coarsely precharged by charging an input terminal and an output terminal of the output buffer to the coarse grayscale voltage so that the output buffer outputs an output voltage having the level of the coarse grayscale voltage.

For example, in an n-th horizontal period, the first output buffer OBF1 may be precharged based on an (n+1)-th coarse grayscale voltage provided from the first decoder DEC1, and the second output buffer OBF2 may drive a source line based on an n-th fine grayscale voltage provided from the second decoder DEC2. In an (n+1)-th horizontal period, the first output buffer OBF1 may drive a source line based on an (n+1)-th fine grayscale voltage provided from the second decoder DEC2, and the second output buffer OBF2 may be precharged based on an (n+2)-th coarse grayscale voltage provided from the first decoder DEC1.

Here, the n-th fine grayscale voltage may be generated based on n-th pixel data, the (n+1)-th coarse grayscale voltage and the (n+1)-th fine grayscale voltage may be generated based on (n+1)-th pixel data, and the (n+2)-th coarse grayscale voltage may be generated based on (n+2)-th pixel data. The n-th pixel data, the (n+1)-th pixel data, and the (n+2)-th pixel data may correspond to pixels arranged in an n-th row, an (n+1)-th row, and an (n+2)-th row respectively.

In an embodiment, at the beginning of the (n+1)-th horizontal period or the end of the n-th horizontal period, the first output buffer OBF1 may drive a source line based on the (n+1)-th coarse grayscale voltage provided from the first decoder DEC1. At this time, the second output buffer OBF2 may be temporarily disabled and may be enabled when the source line voltage reaches or approaches the (n+1)-th coarse grayscale voltage provided from the first decoder DEC1. The (n+1)-th coarse grayscale voltage provided from the first decoder DEC1 at the beginning of the (n+1)-th horizontal period or the end of the n-th horizontal period may be a pre-emphasis output voltage which shortens delay for second output buffer OBF2 to drive the source line to the (n+1)-th fine grayscale voltage provided from the second decoder DEC2. The (n+1)-th coarse grayscale voltage (i.e., pre-emphasis output signal) provided from the first decoder DEC1 may be greater than the (n+1)-th fine grayscale voltage provided from the second decoder DEC2.

The data value of pixel data may be changed for each row of the display panel 200. Due to an internal circuit and an output terminal of a decoder that outputs a grayscale voltage according to pixel data and due to an input terminal of an output buffer that generates a pixel voltage based on the grayscale voltage from the decoder, there may be a significant delay time until the decoder updates the grayscale voltage based on a changed data value of the pixel data and the input terminal and output terminal of the output buffer are charged to the updated grayscale voltage.

To increase the load charge rate (i.e., the rate at which the display panel 200 is charged) of the display panel 200 in a single horizontal period, a driving channel DC may reduce a delay time by driving a source line of the display panel 200 based on pixel data (e.g., the n-th pixel data) while performing precharging based on pixel data of a subsequent row (e.g., the (n+1)-th pixel data). For this operation, the driving channel DC may include two decoders and two output buffers rather than one decoder and one output buffer, and accordingly, the circuit size of the driving channel DC may increase.

However, according to an embodiment, the source driver 110 may drive a source line according to a coarse precharge-fine driving method by using the first decoder DEC1 and the second decoder DEC2, which are included in each of the driving channels DC1 to DCk and have different resolutions from each other, thereby minimizing the increase of the circuit size, increasing the load charge rate of the display panel 200, and reducing a settling time taken for the source line to be charged (or settled) to a pixel voltage.

FIG. 2 illustrates the source driver 110 according to an embodiment.

Referring to FIG. 2, the source driver 110 may include the driving channel DC, a first gamma generator GG1, and a second gamma generator GG2. Although only one driving channel DC is illustrated in FIG. 2 for convenience of description, the source driver 110 may include the plurality of driving channels DC1 to DCk (in FIG. 1), as described with reference to FIG. 1.

Each of the first gamma generator GG1 and the second gamma generator GG2 may include buffers and a voltage divider including a resistor string. The voltage divider may generate a plurality of grayscale voltages by dividing a received power supply voltage, and the buffers may buffer the grayscale voltages before outputting the plurality of grayscale voltages.

The first gamma generator GG1 may generate a first grayscale voltage set VG1 including 2^{N} grayscale voltages V[2^{N}:1]. The second gamma generator GG2 may generate a second grayscale voltage set VG2 including 2^{M} grayscale voltages V[2^{M}:1]. The first gamma generator GG1 may be a coarse gamma generator, and the second gamma generator GG2 may be a fine gamma generator.

The minimum to maximum voltage range of the first grayscale voltage set VG1 may be the same as that of the second grayscale voltage set VG2. A voltage difference between two adjacent grayscales in the first grayscale voltage set VG1 may be greater than a voltage difference between two adjacent grayscales in the second grayscale voltage set VG2. The size of the first gamma generator GG1 may be less than the size of the second gamma generator GG2. Current consumption (or static current) of the first gamma generator GG1 may be less than current consumption of the second gamma generator GG2.

The driving channel DC may include a latch circuit LCB, a decoder circuit DECB, an input switch circuit ISC, an output buffer circuit BFB, and an output switch circuit OCC.

The latch circuit LCB may include a first latch LC1 and a second latch LC2. The first latch LC1 and the second latch LC2 may each sample and store pixel data DT. The first latch LC1 and the second latch LC2 may respectively provide data stored therein to the first decoder DEC1 and the second decoder DEC2.

In an embodiment, the first latch LC1 may store N bits among the M bits of the pixel data DT and may provide the stored N-bit data to the first decoder DEC1 as coarse data CD. In an embodiment, the first latch LC1 may store upper N bits in the pixel data DT. However, embodiments are not limited thereto. In some embodiments, the first latch LC1 may store all of the M bits of the pixel data DT and provide N bits among the stored M bits to the first decoder DEC1 as the coarse data CD.

The second latch LC2 may store the pixel data DT. For example, the second latch LC2 may store all the M bits of the pixel data DT. In an embodiment, the second latch LC2 may store at least two pieces of pixel data DT respectively corresponding to at least two rows of the display panel 200 (in FIG. 1). For example, the second latch LC2 may store n-th pixel data DT and (n+1)-th pixel data DT. The second latch LC2 may provide data stored therein to the second decoder DEC2 as fine data FD.

The decoder circuit DECB may include the first decoder DEC1 (e.g., an N-bit decoder) and the second decoder DEC2 (e.g., an M-bit decoder). The first decoder DEC1 may change the coarse data CD including N bits into a coarse grayscale voltage VCG (e.g., a first grayscale voltage), and the second decoder DEC2 may change the fine data FD including M bits into a fine grayscale voltage VFG (e.g., a second grayscale voltage).

The first decoder DEC1 may select one of the 2^{N} grayscale voltages V[2^{N}:1] in the first grayscale voltage set VG1 provided from the first gamma generator GG1, based on the N-bit coarse data CD, and may output the selected grayscale voltage as the coarse grayscale voltage VCG.

The second decoder DEC2 may select one of the 2^{M} grayscale voltages V[2^{M}:1] in the second grayscale voltage set VG2 provided from the second gamma generator GG2, based on the M-bit fine data FD, and may output the selected grayscale voltage as the fine grayscale voltage VFG.

Each of the first decoder DEC1 and the second decoder DEC2 may include a digital-to-analog converter (DAC) circuit. The first decoder DEC1 may include an N-bit DAC circuit, and the second decoder DEC2 may include an M-bit DAC circuit.

The first decoder DEC1 may include a plurality of switching elements, which receive the 2^{N} grayscale voltages V[2^{N}:1] as inputs and output one of the 2^{N} grayscale voltages V[2^{N}:1] based on the N-bit coarse data CD. The second decoder DEC2 may include a plurality of switching elements, which receive the 2^{M} grayscale voltages V[2^{M}:1] as inputs and output one of the 2^{M} grayscale voltages V[2^{M}:1] based on the M-bit fine data FD. Each of the switching elements may include a transistor. For example, each of the switching elements may include a p-type metal-oxide semiconductor (PMOS) transistor (e.g., a p-type MOS field-effect transistor (FET)), an n-type MOS (NMOS) transistor (e.g., an n-type MOSFET), or complementary MOS (CMOS) transistors.

The number of switching elements in the first decoder DEC1 may be less than the number of switching elements in the second decoder DEC2, and therefore, the circuit size of the first decoder DEC1 may be less than the circuit size of the second decoder DEC2.

The input switch circuit ISC may provide one of the coarse grayscale voltage VCG output from the first decoder DEC1 and the fine grayscale voltage VFG output from the second decoder DEC2 to the first output buffer OBF1 of the output buffer circuit BFB and may provide the other one of the coarse grayscale voltage VCG and the fine grayscale voltage VFG to the second output buffer OBF2 of the output buffer circuit BFB.

The input switch circuit ISC may include a plurality of input switches SWI11, SWI12, SWI21, and SWI22. Each of the input switches SWI11, SWI12, SWI21, and SWI22 may be turned on based on an on-level (e.g., logic high) of a received input switching signal among a plurality of input switching signals SSI11, SSI12, SSI21, and SSI22 and may be turned off based on an off-level (e.g., logic low) of the received input switching signal.

The output buffer circuit BFB may include the first output buffer OBF1 and the second output buffer OBF2. Each of the first output buffer OBF1 and the second output buffer OBF2 may buffer and output a received input voltage. Each of the first output buffer OBF1 and the second output buffer OBF2 may include an amplifier (e.g., a differential amplifier or an operational amplifier). In an embodiment, each of the first output buffer OBF1 and the second output buffer OBF2 may include a rail-to-rail operational amplifier including a first input stage and a second input stage, which operate based on different bias currents and have a symmetrical structure. The first output buffer OBF1 and the second output buffer OBF2 may be the same in terms of circuit design.

The output switch circuit OCC may provide, as a pixel voltage (or an image signal), one of an output voltage of the first output buffer OBF1 and an output voltage of the second output buffer OBF2 to a source line SL of the display panel 200 through an output pad PD.

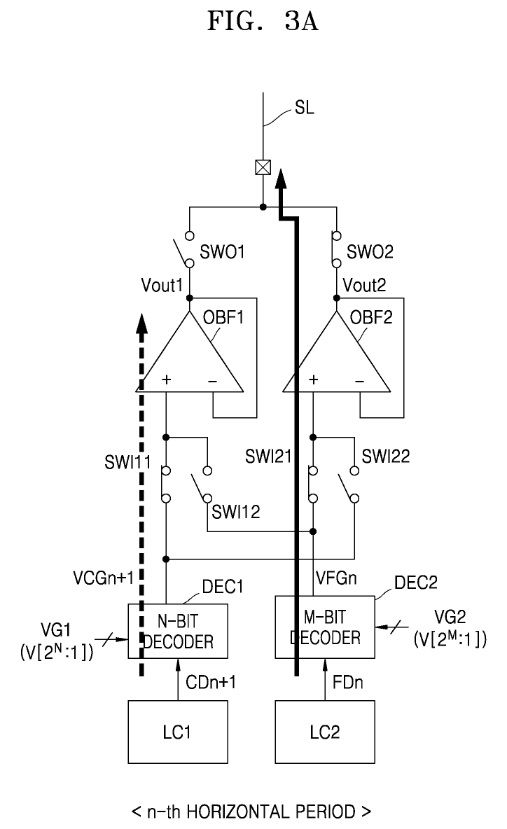

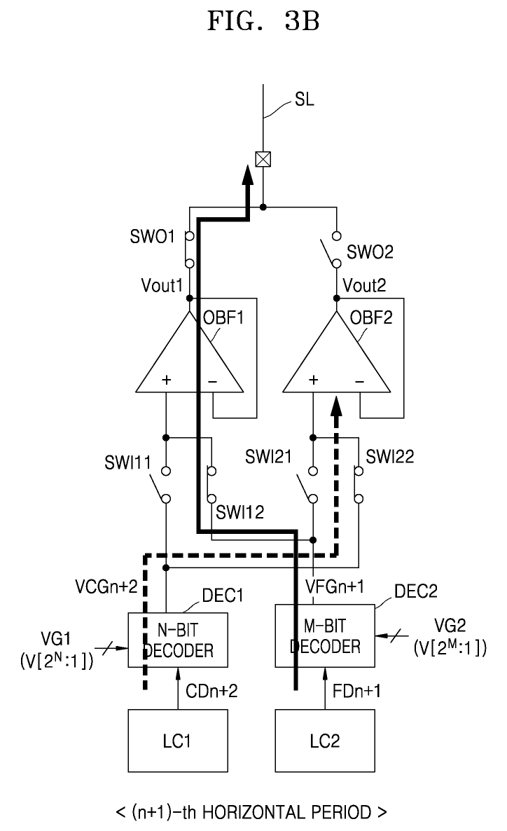

The output switch circuit OCC may include a first output switch SWO1 and a second output switch SWO2. The first output switch SWO1 may be turned on based on an on-level of an output switching signal SSO1 and turned off based on an off-level of the output switching signal SSO1. The second output switch SWO2 may be turned on based on an on-level of an output switching signal SSO2 and turned off based on an off-level of the output switching signal SSO2. The first output switch SWO1 may be turned on and provide a first output voltage Vout1 (in FIG. 3A) of the first output buffer OBF1 to the source line SL through the output pad PD. The second output switch SWO2 may be turned on and provide a second output voltage Vout2 (in FIG. 3A) of the second output buffer OBF2 to the source line SL through the output pad PD.

The panel load of the display panel 200 may be modeled as a resistor R and a capacitor C. Due to an RC delay, a settling time point at which a second point P2 of the source line SL, which is far from the output pad PD to which a pixel voltage is applied, is charged to a target level may be later than a settling time point at which a first point P1 of the source line SL, which is close to the output pad PD, is charged to the target level. The driving channel DC may drive the source line SL according to a coarse precharge-fine driving method according to an embodiment so that the second point P2 as well as the first point P1 of the source line SL is charged to the target level in shorter time and may have a significant margin time during which the source line SL maintains the target level in a single horizontal period.

FIGS. 3A and 3B illustrate operations of a driving channel according to an embodiment.

FIG. 3A illustrates the operation of the driving channel in the n-th horizontal period. FIG. 3B illustrates the operation of the driving channel in the (n+1)-th horizontal period.

Referring to FIG. 3A, in the n-th horizontal period, the first decoder DEC1 may convert (n+1)-th coarse data CDn+1 into an (n+1)-th coarse grayscale voltage VCGn+1, and the second decoder DEC2 may convert n-th fine data FDn into an n-th fine grayscale voltage VFGn.

The input switches SWI11 and SWI21 may be turned on, and the input switches SWI12 and SWI22 may be turned off. The output switch SWO1 may be turned off, and the output switch SWO2 may be turned on. Accordingly, while the second output buffer OBF2 is driving the source line SL based on the n-th fine grayscale voltage VFGn received from the second decoder DEC2, the first output buffer OBF1 may be precharged based on the (n+1)-th coarse grayscale voltage VCGn+1 received from the first decoder DEC1.

Referring to FIG. 3B, in the (n+1)-th horizontal period, the first decoder DEC1 may convert (n+2)-th coarse data CDn+2 into an (n+2)-th coarse grayscale voltage VCGn+2, and the second decoder DEC2 may convert (n+1)-th fine data FDn+1 into an (n+1)-th fine grayscale voltage VFGn+1. Because the (n+1)-th coarse grayscale voltage VCGn+1 generated by the first decoder DEC1 in the n-th horizontal period and the (n+1)-th fine grayscale voltage VFGn+1 generated by the second decoder DEC2 in the (n+1)-th horizontal period are generated based on the same (n+1)-th pixel data, the (n+1)-th coarse grayscale voltage VCGn+1 and the (n+1)-th fine grayscale voltage VFGn+1 may be the same as or similar to each other. For example, the voltage difference between the (n+1)-th coarse grayscale voltage VCGn+1 and the (n+1)-th fine grayscale voltage VFGn+1 may be a 2^{M-N} grayscale difference or less.

The input switches SWI12 and SWI22 may be turned on, and the input switches SWI11 and SWI21 may be turned off. The output switch SWO2 may be turned off, and the output switch SWO1 may be turned on. Accordingly, while the first output buffer OBF1 is driving the source line SL based on the (n+1)-th fine grayscale voltage VFGn+1 received from the second decoder DEC2, the second output buffer OBF2 may be precharged based on the (n+2)-th coarse grayscale voltage VCGn+2 received from the first decoder DEC1.

As described above, while the second output buffer OBF2 is driving the source line SL based on a fine grayscale voltage from the second decoder DEC2, the first output buffer OBF1 may be precharged based on a coarse grayscale voltage from the first decoder DEC1. Thereafter, while the first output buffer OBF1 is driving the source line SL based on a fine grayscale voltage from the second decoder DEC2, the second output buffer OBF2 may be precharged based on a coarse grayscale voltage from the first decoder DEC1.

The first decoder DEC1 having a lower resolution than the second decoder DEC2 may generate a coarse grayscale voltage, e.g., a precharge voltage, and the second decoder DEC2 may generate a fine grayscale voltage, e.g., a pixel voltage provided to the source line SL. When the input switch circuit ISC switches the transmission paths of the coarse grayscale voltage and the fine grayscale voltage, the first output buffer OBF1 and the second output buffer OBF2 may be alternately precharged. In addition, when the output switch circuit OCC alternately transmit the output voltage of the first output buffer OBF1 and the output voltage of the second output buffer OBF2 to the output pad PD, the first output buffer OBF1 and the second output buffer OBF2 may alternately drive the source line SL.

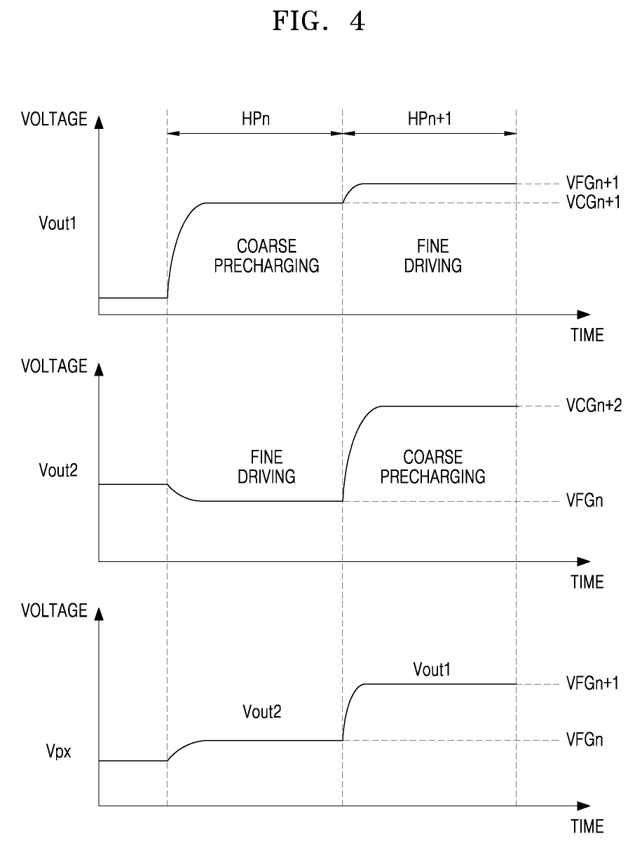

FIG. 4 illustrates output voltages of a driving channel, according to an embodiment.

Referring to FIGS. 3 and 4, in an n-th horizontal period HPn, the first output buffer OBF1 may undergo coarse precharging, and the second output buffer OBF2 may perform fine driving. The first output voltage Vout1 of the first output buffer OBF1 may be charged to the (n+1)-th coarse grayscale voltage VCGn+1. The second output buffer OBF2 may generate the second output voltage Vout2 based on the n-th fine grayscale voltage VFGn. The second output voltage Vout2 of the second output buffer OBF2 may be output to the source line SL as a pixel voltage Vpx through the output pad PD.

In an (n+1)-th horizontal period HPn+1, the first output buffer OBF1 may perform fine driving, and the second output buffer OBF2 may undergo coarse precharging. The first output buffer OBF1 may generate the first output voltage Vout1 based on the (n+1)-th fine grayscale voltage VFGn+1. The second output buffer OBF2 may be precharged to the (n+2)-th coarse grayscale voltage VCGn+2. The first output voltage Vout1 of the first output buffer OBF1 may be output to the source line SL as the pixel voltage Vpx through the output pad PD.

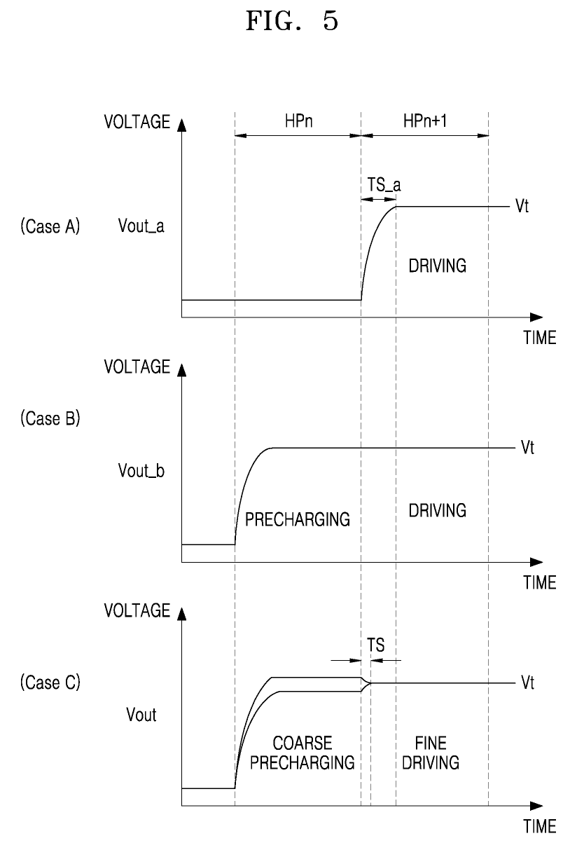

FIG. 5 illustrates output voltages of an output buffer, according to an embodiment and comparative examples.

In a first comparative example in which a driving channel includes one output buffer, an output voltage Vout_a of case A refers to an output voltage of the output buffer. In a second comparative example in which a driving channel includes two identical decoders and two output buffers, an output voltage Vout_b of case B refers to an output voltage of a first output buffer. In an embodiment in which a driving channel includes two decoders having different resolutions from each other and two output buffers, an output voltage Vout of case C refers to an output voltage of a first output buffer.

When the difference between a data value of pixel data in the n-th horizontal period HPn and a data value of pixel data in the (n+1)-th horizontal period HPn+1 is large, in case A, a change in the output voltage Vout_a of the output buffer may be large and it may take a significant settling time TS_a for the output voltage Vout_a to be settled to a target level Vt (e.g., a grayscale voltage corresponding to (n+1)-th pixel data).

In case B, two output buffers may alternately drive a source line. In the n-th horizontal period HPn, the first output buffer may be precharged based on a grayscale voltage corresponding to the (n+1)-th pixel data, and the output voltage Vout_b of the first output buffer may be charged to the target level Vt. In the (n+1)-th horizontal period, the first output buffer may generate the output voltage Vout_b based on a grayscale voltage corresponding to the (n+1)-th pixel data, and the output voltage Vout_b may be the same as the output voltage Vout_b generated in the n-th horizontal period HPn. Because the output voltage Vout_b is precharged to the target level Vt in the n-th horizontal period HPn, there may be no settling time in the (n+1)-th horizontal period HPn+1.

In the driving channel according to an embodiment in case C, in the n-th horizontal period HPn, the first output buffer may undergo coarse precharging based on a coarse grayscale voltage corresponding to some bits among the bits (e.g., N bits among M bits) of the (n+1)-th pixel data, and the output voltage Vout of the first output buffer may be charged to a level that is lower or higher than the target level Vt. In the (n+1)-th horizontal period HPn+1, the first output buffer may generate the output voltage Vout based on a grayscale voltage (e.g., a fine grayscale voltage) corresponding to the (n+1)-th pixel data. Because the fine grayscale voltage is similar to the coarse grayscale voltage, a settling time TS of the output voltage Vout may be significantly shorter compared to the settling time TS_a of case A. In case C, the first output buffer may undergo coarse precharging based on the coarse grayscale voltage, and the size of a decoder generating the coarse grayscale voltage may be smaller than the size of a decoder generating the fine grayscale voltage. Accordingly, in the embodiment in case C, the circuit size may be smaller than that of the Case B, and the settling time of the output voltage Vout may be shorter than that of the Case A.

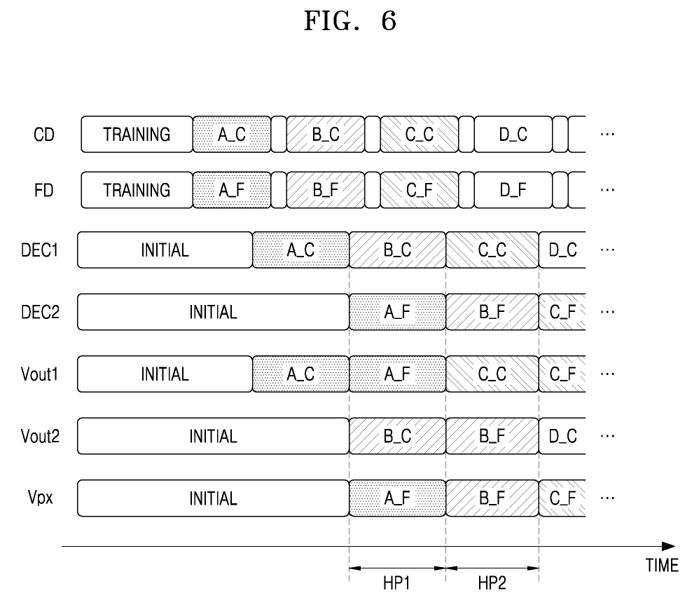

FIG. 6 illustrates data received by a driving channel and outputs generated based on the data, according to an embodiment.

Referring to FIGS. 2 and 6, after the first latch LC1 and the second latch LC2 are trained, the coarse data CD and the fine data FD may be sampled and stored in the first latch LC1 and the second latch LC2, respectively. The coarse data CD and the fine data FD may be generated based on the same pixel data. For example, the coarse data CD may include N bits among the M bits of the pixel data, and the fine data FD may include the M bits of the pixel data.

Based on pixel data A, B, C, and D which correspond to four pixels connected to the same source line and arranged in four consecutive rows of the display panel 200, coarse data A_C, B_C, C_C, and D_C may be sequentially sampled and stored in the first latch LC1, and fine data A_F, B_F, C_F, and D_F may be sequentially sampled and stored in the second latch LC2.

Before a first horizontal period HP1, the first decoder DEC1 may generate a coarse grayscale voltage based on the coarse data A_C, and the first output buffer OBF1 may undergo coarse precharging based on the coarse grayscale voltage. The first output voltage Vout1 of the first output buffer OBF1 may correspond to the coarse data A_C.

In the first horizontal period HP1, the second decoder DEC2 may generate a fine grayscale voltage based on the fine data A_F, and the first output buffer OBF1 may generate the first output voltage Vout1 based on the fine grayscale voltage. The first output voltage Vout1 may correspond to the fine data A_F. The first output voltage Vout1 may be output to the source line SL as the pixel voltage Vpx through the output pad PD.

In the first horizontal period HP1, the first decoder DEC1 may generate a coarse grayscale voltage based on the coarse data B_C, and the second output buffer OBF2 may undergo coarse precharging based on the coarse grayscale voltage. The second output voltage Vout2 of the second output buffer OBF2 may correspond to the coarse data B_C.

In a second horizontal period HP2, the second decoder DEC2 may generate a fine grayscale voltage based on the fine data B_F, and the second output buffer OBF2 may generate the second output voltage Vout2 based on the fine grayscale voltage. The second output voltage Vout2 may correspond to the fine data B_F. The second output voltage Vout2 may be output to the source line SL as the pixel voltage Vpx through the output pad PD.

In the second horizontal period HP2, the first decoder DEC1 may generate a coarse grayscale voltage based on the coarse data C_C, and the first output buffer OBF1 may undergo coarse precharging based on the coarse grayscale voltage. The first output voltage Vout1 of the first output buffer OBF1 may correspond to the coarse data C_C.

In subsequent horizontal periods, the first decoder DEC1 may generate a coarse grayscale voltage based on the coarse data D_C, the second decoder DEC2 may generate fine grayscale voltages respectively based on the fine data C_F and the fine data D_F, and the first output buffer OBF1 and the second output buffer OBF2 may alternately undergo coarse precharging and may alternately drive the source line based on the coarse grayscale voltage and the fine grayscale voltage.

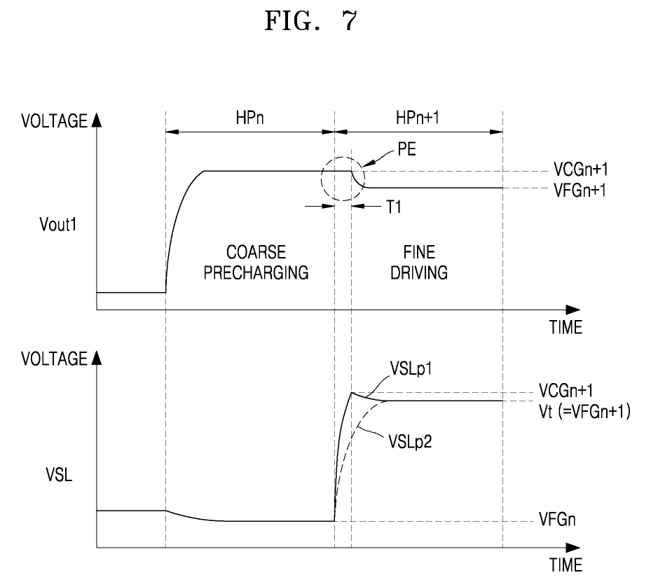

FIG. 7 is a timing diagram illustrating an operating method of a driving channel, according to an embodiment.

FIG. 7 illustrates the first output voltage Vout1 of the first output buffer OBF1 of the driving channel DC in FIG. 2 and a voltage VSL of the source line SL.

According to a coarse precharge-fine driving method of an embodiment, the first output buffer OBF1 may undergo coarse precharging based on the (n+1)-th coarse grayscale voltage VCGn+1 provided from the first decoder DEC1 in the n-th horizontal period HPn and may perform fine driving based on the (n+1)-th fine grayscale voltage VFGn+1 provided from the second decoder DEC2 in the (n+1)-th horizontal period HPn+1.

Referring to FIG. 7, in a period T1 of the (n+1)-th horizontal period HPn+1, the first output buffer OBF1 may generate the first output voltage Vout1 based on the (n+1)-th coarse grayscale voltage VCGn+1 provided from the first decoder DEC1 and may provide the first output voltage Vout1 to the source line SL. A method of driving a source line based on coarse grayscale voltage before fine driving the source line in one horizontal period, as described above, may be referred to as coarse driving.

The second decoder DEC2 may generate the n-th fine grayscale voltage VFGn based on the n-th pixel data in the n-th horizontal period HPn and may generate the (n+1)-th fine grayscale voltage VFGn+1 based on the (n+1)-th pixel data in the (n+1)-th horizontal period HPn+1. When the level difference between the n-th fine grayscale voltage VFGn and the (n+1)-th fine grayscale voltage VFGn+1 is large, a delay may occur when the output of the second decoder DEC2 transitions or charges from the n-th fine grayscale voltage VFGn to the (n+1)-th fine grayscale voltage VFGn+1.

The first output buffer OBF1 may perform coarse driving the source line SL based on the (n+1)-th coarse grayscale voltage VCGn+1 similar to the (n+1)-th fine grayscale voltage VFGn+1 in the period T1 (e.g., the beginning) of the (n+1)-th horizontal period HPn+1. At this time, the output of the second decoder DEC2 may be changed from the n-th fine grayscale voltage VFGn to the (n+1)-th fine grayscale voltage VFGn+1. After the output of the second decoder DEC2 is completely changed to the (n+1)-th fine grayscale voltage VFGn+1, the first output buffer OBF1 may perform fine driving based on the (n+1)-th fine grayscale voltage VFGn+1, thereby preventing the delay time, which occurs in changing the output of the second decoder DEC2, from affecting a settling time of a pixel voltage provided to the source line SL.

The (n+1)-th coarse grayscale voltage VCGn+1 may be higher than the (n+1)-th fine grayscale voltage VFGn+1. The first output voltage Vout1 that is generated based on the (n+1)-th coarse grayscale voltage VCGn+1 and provided to the source line SL in the period T1 may be used as a pre-emphasis (PE) voltage. A voltage VSLp1 at the point P1 of the source line SL, which is close to the output pad PD to which the first output voltage Vout1 is applied as a pixel voltage, may rise to the (n+1)-th coarse grayscale voltage VCGn+1 that is higher than the target level Vt (e.g., the (n+1)-th fine grayscale voltage VFGn+1) and may then converge to the target level Vt after the period T1. A voltage VSLp2 at the second point P2 of the source line SL, which is far from the output pad PD, may rise more slowly than the voltage VSLp1 at the first point P1 due to an RC delay. However, because of PE using the (n+1)-th coarse grayscale voltage VCGn+1, the voltage VSLp2 at the second point P2 may rise more quickly than in the case where PE driving is not used. Accordingly, a settling time of the voltage VSL of the source line SL may be reduced.

In an embodiment, the coarse driving described with reference to FIG. 7 may be performed when the difference between a data value of the n-th pixel data and a data value of the (n+1)-th pixel data is equal to or greater than a threshold value. When the difference between the data values is less than the threshold value, the first output buffer OBF1 may perform fine driving based on the (n+1)-th fine grayscale voltage VFGn+1 in the (n+1)-th horizontal period HPn+1 without the coarse driving.

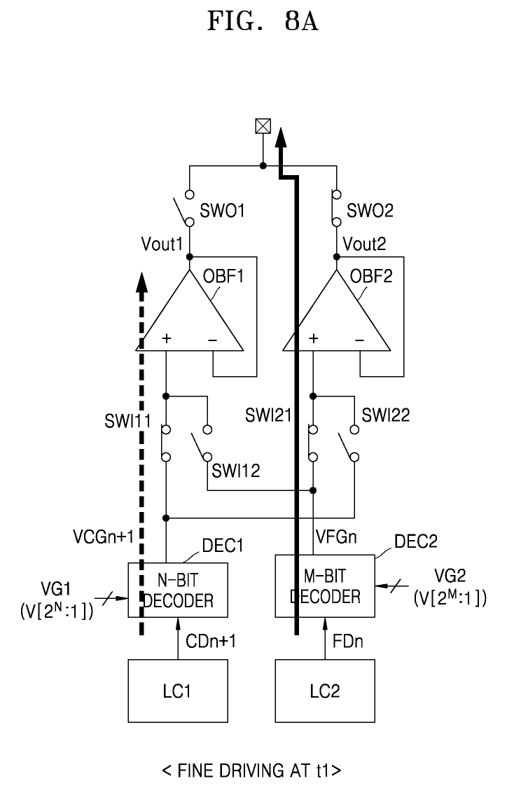

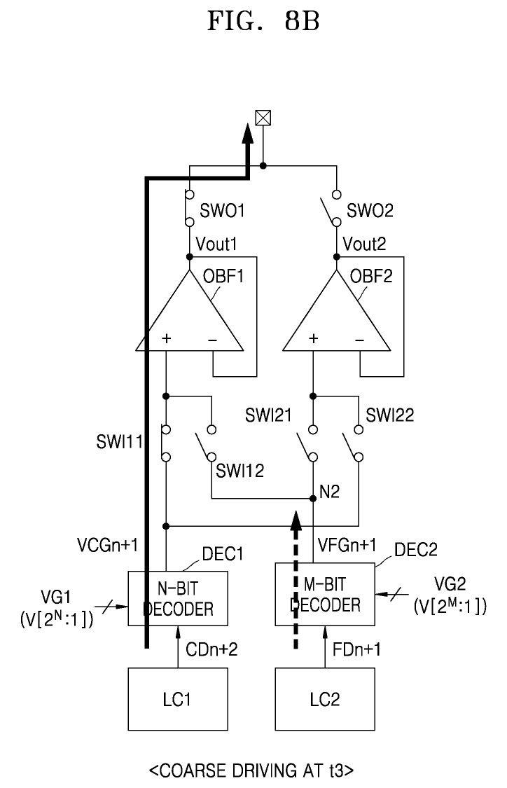

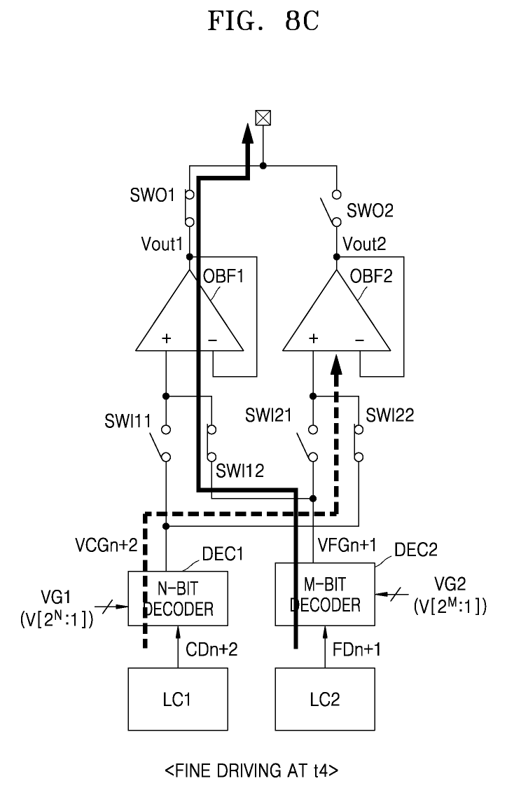

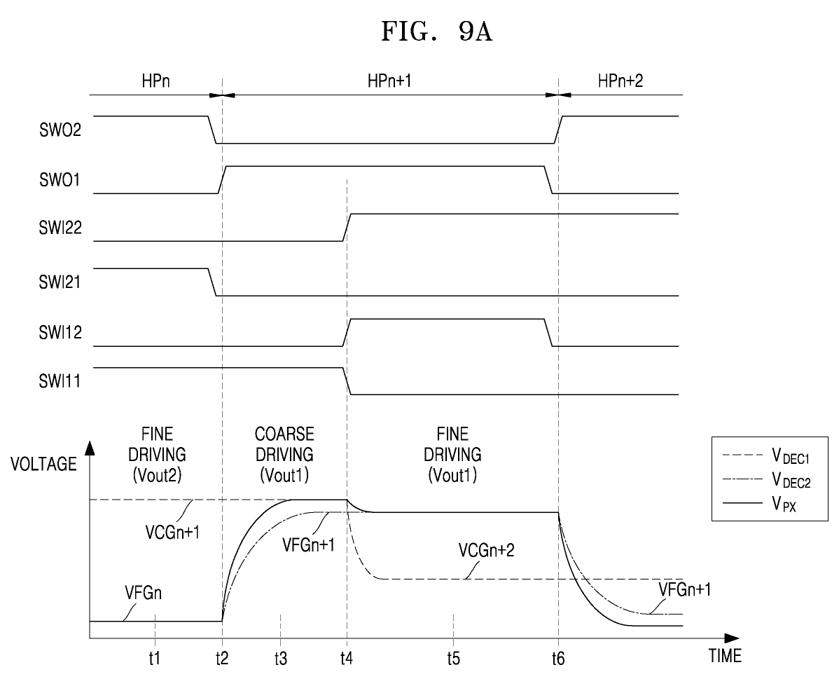

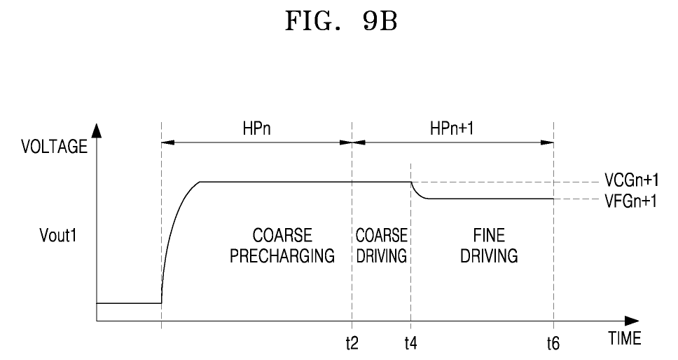

FIGS. 8A to 8C illustrate operations of a driving channel, according to an embodiment. FIGS. 9A and 9B are timing diagrams of a driving channel according to an embodiment. The operations of the driving channel illustrated in FIGS. 8A to 8C are described with reference to the timing diagrams of FIGS. 9A and 9B. In FIG. 9A, on- and off-states of the input switches SWI11, SWI12, SWI21, and SWI22 and the output switches SWO1 and SWO2 are represented by logic levels of the signals, in which a logic high signal represents the on-state, and a logic low signal represents the off-state.

Referring to FIG. 9A, the second output buffer OBF2 may perform fine driving of a source line in the n-th horizontal period HPn before a time point t2.

FIG. 8A illustrates the operation of the driving channel DC at a time point t1 in the n-th horizontal period HPn during the fine driving by the second output buffer OBF2.

The input switches SWI11 and SWI21 and the output switch SWO1 may be in the on-state, and the input switches SWI12 and SWI22 and the output switch SWO1 may be in the off-state.

The first decoder DEC1 may output the (n+1)-th coarse grayscale voltage VCGn+1, and the second decoder DEC2 may output the n-th fine grayscale voltage VFGn.

The first output buffer OBF1 may undergo coarse precharging based on the (n+1)-th coarse grayscale voltage VCGn+1. As shown in FIG. 9B, the level of the first output voltage Vout1 of the first output buffer OBF1 may be the same as the level of the (n+1)-th coarse grayscale voltage VCGn+1.

The second output buffer OBF2 may perform fine driving based on the n-th fine grayscale voltage VFGn. The level of the pixel voltage Vpx provided to the source line may be the same as the level of the n-th fine grayscale voltage VFGn.

Before the time point t2 at which the (n+1)-th horizontal period HPn+1 begins, the output switch SWO2 and the input switch SWI21 may be turned off. Thereafter, at the time point t2, the output switch SWO1 may be turned on. Because the output switch SWO1 is turned on after the output switch SWO2 is turned off, a short-circuit between the first output voltage Vout1 of the first output buffer OBF1 and the second output voltage Vout2 of the second output buffer OBF2 due to the simultaneous on-state of the output switches SWO1 and SWO2 may be prevented.

In a period from the time point t2 to a time point t4, the first output buffer OBF1 may perform coarse driving on the source line based on the (n+1)-th coarse grayscale voltage VCGn+1.

FIG. 8B illustrates the operation of the driving channel DC at a time point t3 in the (n+1)-th horizontal period HPn+1 during the coarse driving by the first output buffer OBF1. The output signal of the first output buffer OBF1 at time point t4 may be a first precharge output signal.

The first output buffer OBF1 may perform the coarse driving on the source line based on the (n+1)-th coarse grayscale voltage VCGn+1. As shown in FIG. 9B, the level of the first output voltage Vout1 of the first output buffer OBF1 may be the same as the level of the (n+1)-th coarse grayscale voltage VCGn+1. The level of the pixel voltage Vpx may increase from the n-th fine grayscale voltage VFGn to the (n+1)-th coarse grayscale voltage VCGn+1.

At this time, the second decoder DEC2 may generate the (n+1)-th fine grayscale voltage VFGn+1 based on the (n+1)-th fine data FDn+1. An output voltage V_{DEC2} of the second decoder DEC2 may increase from the n-th fine grayscale voltage VFGn to the (n+1)-th fine grayscale voltage VFGn+1. An output node N2 of the second decoder DEC2 may be charged to the (n+1)-th fine grayscale voltage VFGn+1.

The second output buffer OBF2 may be disabled. For example, a first input terminal (e.g., + input) of the second output buffer OBF2 may be floated.

At the time point t4, the input switches SWI12 and SWI22 may be turned on, and the input switch SWI11 may be turned off.

In a period from the time point t4 to a time point t6, the first output buffer OBF1 may perform fine driving on the source line based on the (n+1)-th fine grayscale voltage VFGn+1.

FIG. 8C illustrates the operation of the driving channel DC at a time point t5 in the (n+1)-th horizontal period HPn+1 during the fine driving by the first output buffer OBF1.

The first output buffer OBF1 may perform the fine driving on the source line based on the (n+1)-th fine grayscale voltage VFGn+1 provided from the second decoder DEC2. As shown in FIG. 9B, the level of the first output voltage Vout1 of the first output buffer OBF1 may be the same as the level of the (n+1)-th fine grayscale voltage VFGn+1. The level of the pixel voltage Vpx may fall (or change) from the level of the (n+1)-th coarse grayscale voltage VCGn+1 to the level of the (n+1)-th fine grayscale voltage VFGn+1.

At this time, the first decoder DEC1 may generate the (n+2)-th coarse grayscale voltage VCGn+2 based on the (n+2)-th coarse data CDn+2. The level of an output voltage V_{DEC1} of the first decoder DEC1 may fall (or change) from the level of the (n+1)-th coarse grayscale voltage VCGn+1 to the level of the (n+2)-th coarse grayscale voltage VCGn+2. The second output buffer OBF2 may undergo coarse precharging based on the (n+2)-th coarse grayscale voltage VCGn+2.

Before the time point t6 at which an (n+2)-th horizontal period HPn+2 begins, the output switch SWO1 and the input switch SWI12 may be turned off. Thereafter, the output switch SWO2 may be turned on at the time point t6.

After the time point t6, the second output buffer OBF2 may perform coarse driving on the source line based on the (n+2)-th coarse grayscale voltage VCGn+2.

As described above, the first output buffer OBF1 and the second output buffer OBF2 may perform coarse driving based on a coarse grayscale voltage, which is provided from the first decoder DEC1, after coarse precharging and before fine driving. In a period during which the coarse driving is performed, the output node N2 of the second decoder DEC2 may be precharged, and the output voltage of the second decoder DEC2 may be changed from a previous coarse grayscale voltage to a current coarse grayscale voltage. After the output voltage of the second decoder DEC2 is changed to a target level, the first output buffer OBF1 or the second output buffer OBF2 may perform fine driving on the source line based on a fine grayscale voltage provided from the second decoder DEC2.

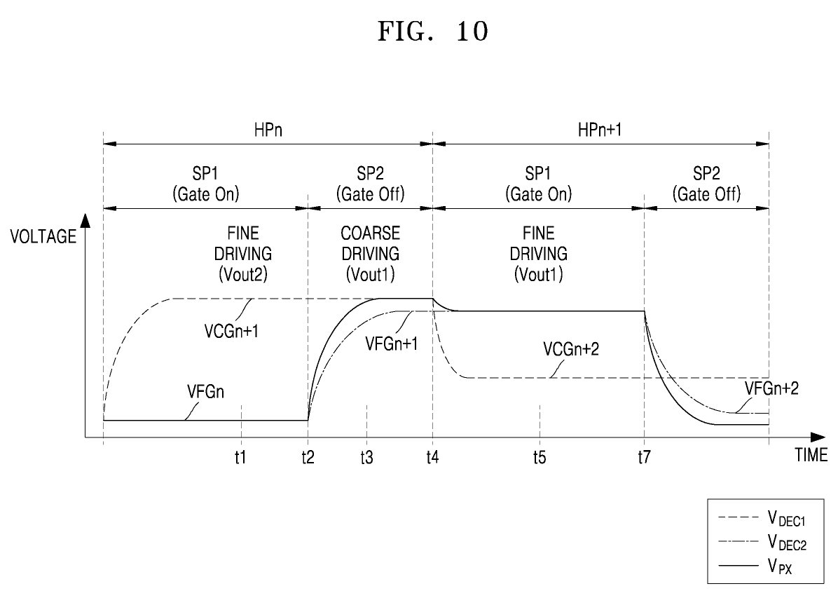

FIG. 10 is a timing diagram of a driving channel according to an embodiment.

As described with reference to FIGS. 7 to 9B, the first output buffer OBF1 and the second output buffer OBF2 may perform coarse driving based on a coarse grayscale voltage provided from the first decoder DEC1 after coarse precharging and before fine driving. In the present embodiment, the coarse driving may be performed at the end of each horizontal period.

Referring to FIG. 10, each horizontal period may include a first sub-period SP1 and a second sub-period SP2. In the first sub-period SP1, a gate-on voltage may be applied to a selected row among a plurality of rows of the display panel 200 (in FIG. 1). In the second sub-period SP2, a gate-off voltage may be applied to the selected row. When the gate-on voltage is applied to the selected row, each of the pixels in the selected row may be electrically connected to a source line and may store a pixel voltage received through the source line. When the gate-off voltage is applied to the selected row, each of the pixels in the selected row may be electrically disconnected from the source line and may emit light based on the pixel voltage stored therein.

The first output buffer OBF1 or the second output buffer OBF2 may undergo coarse precharging based on a coarse grayscale voltage provided from the first decoder DEC1 in the first sub-period SP1 of each horizontal period and may perform coarse driving on a source line based on the coarse grayscale voltage provided from the first decoder DEC1 in the second sub-period SP2 of each horizontal period.

During the coarse driving, the output node N2 of the second decoder DEC2 may be precharged, and the output voltage of the second decoder DEC2 may be changed to a coarse grayscale voltage according to pixel data corresponding to a subsequent horizontal period. After the output voltage of the second decoder DEC2 is changed to a target level, the first output buffer OBF1 or the second output buffer OBF2 may perform fine driving on the source line based on a fine grayscale voltage, which is provided from the second decoder DEC2, in the subsequent horizontal period.

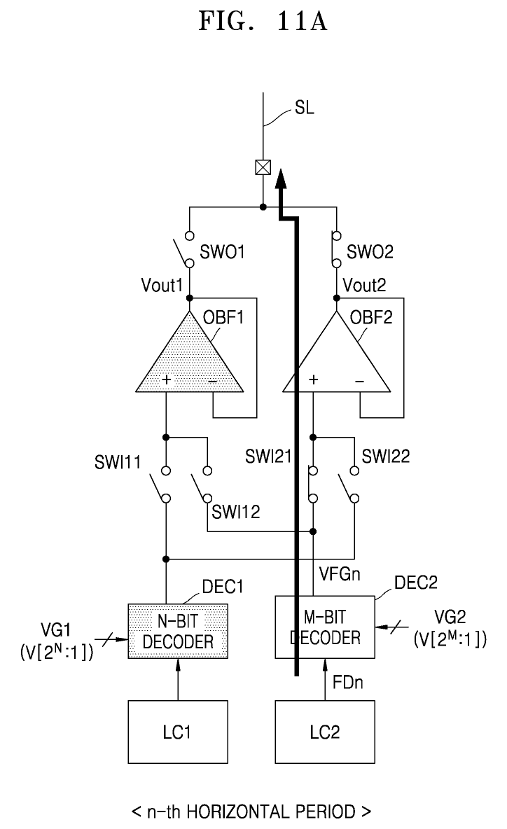

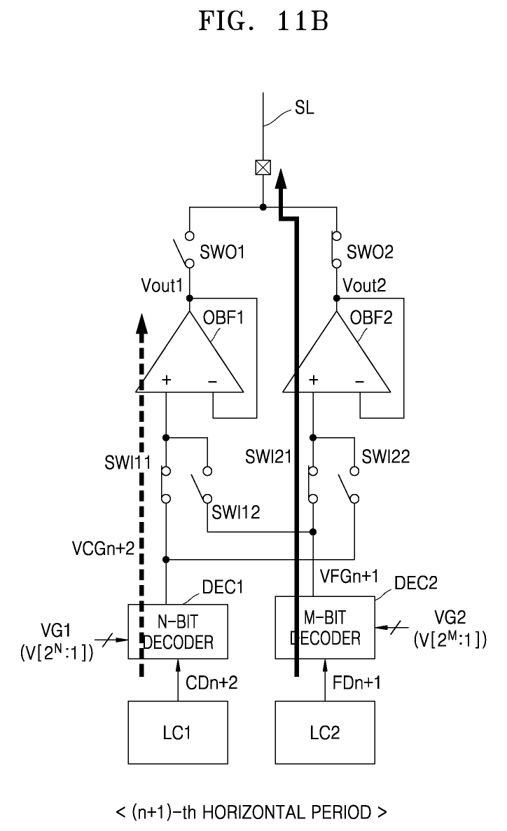

FIGS. 11A and 11B illustrate operations of a driving channel, according to an embodiment.

Referring to FIG. 11A, in an n-th horizontal period, the second output buffer OBF2 may perform fine driving on the source line SL based on the n-th fine grayscale voltage VFGn provided from the second decoder DEC2. At this time, as described with reference to FIG. 3A, the first output buffer OBF1 may undergo coarse precharging based on the (n+1)-th coarse grayscale voltage VCGn+1 provided from the first decoder DEC1.

However, when the difference between a data value of (n+1)-th pixel data and a data value of n-th pixel data is less than a threshold value, coarse precharging may not be performed.

As shown in FIG. 11A, the first output buffer OBF1 and the first decoder DEC1 may be disabled. The input switches SWI11 and SWI12 and the output switch SWO1 may be turned off so that the first output buffer OBF1 does not undergo coarse precharging. For example, bias current of the first output buffer OBF1 may be set to a low current according to a low-power mode. For example, the input and output of the first decoder DEC1 may be blocked.

Referring to FIG. 11B, in an (n+1)-th horizontal period, the second output buffer OBF2 may perform fine driving on the source line SL based on the (n+1)-th fine grayscale voltage VFGn+1 provided from the second decoder DEC2.

When the difference between a data value of (n+2)-th pixel data and the data value of the (n+1)-th pixel data is less than the threshold value, coarse precharging may still not be performed. However, when the difference between the data value of the (n+2)-th pixel data and the data value of the (n+1)-th pixel data is equal to or greater than the threshold value, the first output buffer OBF1 may undergo coarse precharging based on the (n+2)-th coarse grayscale voltage VCGn+2 provided from the first decoder DEC1, as shown in FIG. 11B.

In an (n+2)-th horizontal period following the (n+1)-th horizontal period, the first output buffer OBF1 may perform fine driving on the source line SL based on an (n+1)-th fine grayscale voltage provided from the second decoder DEC2.

As described above, according to an embodiment, the driving channel DC may not perform coarse precharging when the difference between a data value of subsequent pixel data and a data value of current pixel data is less than a threshold value and may perform coarse precharging when the difference between the data values is equal to or greater than the threshold value.

For example, when the image data IDT represents a white image or a black image, there may be no difference between the data value of the current pixel data and the data value of the subsequent pixel data. As described above, when there is no change in pixel data or when a change in pixel data is less than a threshold value, the driving channel DC may not perform coarse precharging, thereby reducing current consumption.

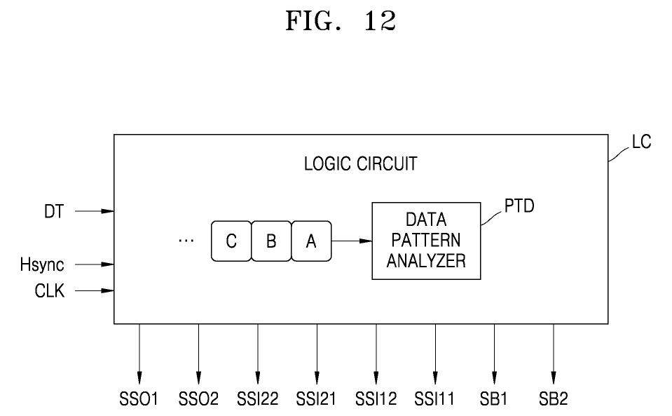

FIG. 12 illustrates a logic circuit LC according to an embodiment.

The logic circuit LC of FIG. 12 may be included in the source driver 110 (in FIG. 1) or each of the driving channels DC1 to DCk (in FIG. 1).

The logic circuit LC may receive the pixel data DT, the horizontal synchronization signal Hsync, and a clock signal CLK and may generate control signals for a driving channel based on the pixel data DT, the horizontal synchronization signal Hsync, and the clock signal CLK. For example, the control signals may include the plurality of input switching signals SSI11, SSI12, SSI21, and SSI22 respectively applied to a plurality of input switches (e.g., SWI11, SWI12, SWI21, and SWI22), and the plurality of output switching signals SSO1 and SSO2 respectively applied to a plurality of output switches (e.g., SWO1 and SWO2). The control signals may also include a first bias control signal SB1 for controlling bias current of the first output buffer OBF1 and a second bias control signal SB2 for controlling bias current of the second output buffer OBF2.

In an embodiment, the logic circuit LC may include a data pattern analyzer PTD. The data pattern analyzer PTD may receive a plurality of pieces of pixel data DT, e.g., pixel data A, B, and C, may calculate differences in data value among the pixel data A, B, and C, and may analyze a data pattern of the pixel data DT. The logic circuit LC may generate the control signals based on an analysis result of the data pattern analyzer PTD. For example, when a data value difference between the pixel data A and the pixel data B is less than a threshold value, the logic circuit LC may generate control signals for the driving channel to skip coarse precharging, as described with reference to FIG. 11A.

As described above, the logic circuit LC may generate control signals for controlling the operations of the driving channel DC described above.

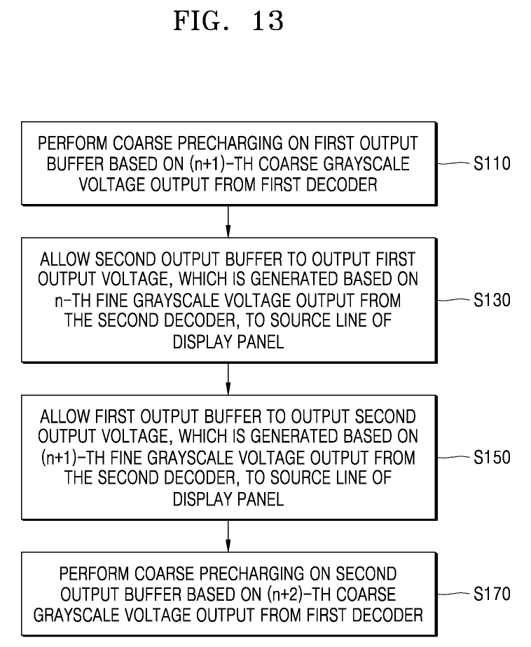

FIG. 13 is a flowchart of an operating method of a source driver, according to an embodiment. In detail, FIG. 13 illustrates an operating method of each of a plurality of driving channels included in the source driver, according to an embodiment. The operating method of a driving channel may be applied to the present embodiment.

Referring to FIG. 13, in an n-th horizontal period, a first output buffer may undergo coarse precharging based on an (n+1)-th coarse grayscale voltage output from a first decoder in operation S110.

In the n-th horizontal period, a second output buffer may output a first output voltage, which is generated based on an n-th fine grayscale voltage output from a second decoder, to a source line of a display panel in operation S130.

Operations S110 and S130 may be performed in parallel in the n-th horizontal period. The resolution of the first decoder may be lower than the resolution of the second decoder.

In an (n+1)-th horizontal period, the first output buffer may output a second output voltage, which is generated based on an (n+1)-th fine grayscale voltage output from the second decoder, to the source line of the display panel in operation S150.

In the (n+1)-th horizontal period, the second output buffer may undergo coarse precharging based on the (n+2)-th coarse grayscale voltage output from the first decoder in operation S170. Operations S150 and S170 may be performed in parallel in the (n+1)-th horizontal period.

In an embodiment, in the n-th horizontal period, the first decoder may select one of 2^{N} grayscale voltages as the (n+1)-th coarse grayscale voltage based on N bits among M bits of (n+1)-th pixel data, and the second decoder may select one of 2^{M} grayscale voltages as the n-th fine grayscale voltage based on M bits of n-th pixel data. Here, the (n+1)-th pixel data may correspond to an (n+1)-th row of the display panel, and the n-th pixel data may correspond to an n-th row of the display panel.

In an embodiment, in the (n+1)-th horizontal period, the first output buffer may output a third output voltage, which is generated based on the(n+1)-th coarse grayscale voltage received from the first decoder, to the source line before the second output voltage is output to the source line. The third output voltage may be higher than the second output voltage.

In an embodiment, in the n-th horizontal period, the first output buffer may output the third output voltage, which is generated based on the(n+1)-th coarse grayscale voltage received from the first decoder, to the source line after the first output voltage is output to the source line.

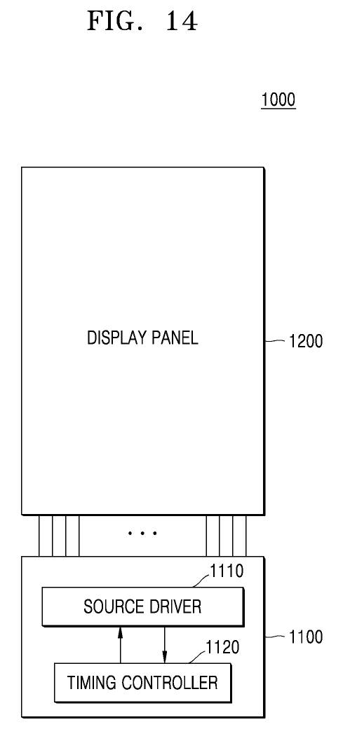

FIG. 14 illustrates an example implementation of a display device 1000 according to an embodiment.

The display device 1000 of FIG. 14 may include a small display panel and may be applied to mobile devices, such as smartphones and tablet PCs.

Referring to FIG. 14, the display device 1000 may include a display driver circuit 1100 and a display panel 1200. The display driver circuit 1100 may include at least one integrated circuit (IC) and may be mounted on a circuit film, such as a tape carrier package (TCP), a chip-on-film (COF), or a flexible printed circuit (FPC). The display driver circuit 1100 may be attached to the display panel 1200 in a tape automatic bonding (TAB) manner or may be mounted on a non-display region (i.e., a region in which an image is not displayed) of the display panel 1200 in a chip-on-glass (COG) manner.

The display driver circuit 1100 may include a source driver 1110 and a timing controller 1120. The display driver circuit 1100 may further include a gate driver. In an embodiment, the gate driver may be mounted on the display panel 1200.

As described above with reference to FIGS. 1 to 13, the source driver 1110 may include a plurality of driving channels. Each of the driving channels may include a first decoder and a second decoder, which have different resolutions from each other, a first output buffer, and a second output buffer. The first output buffer and the second output buffer may alternately undergo coarse precharging based on a coarse grayscale voltage provided from the first decoder and may alternately perform fine driving on a source line of the display panel 1200 based on a fine grayscale voltage provided from the second decoder. Because each driving channel drives a source line according to a coarse precharge-fine driving method, an increase in circuit size may be minimized, the load charge rate of the display panel 1200 may be increased, and a settling time taken for the source line to be charged (or settled) to a pixel voltage may be reduced.

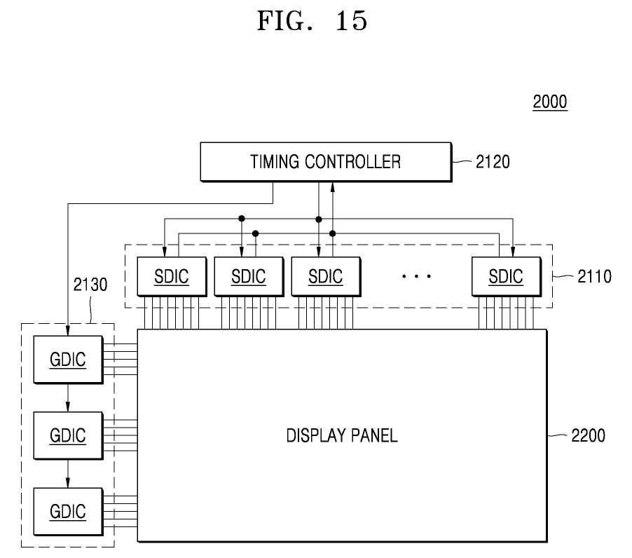

FIG. 15 illustrates an example implementation of a display device according to an embodiment. A display device 2000 of FIG. 15 may include a medium or large display panel and may be applied to, for example, a television or a monitor.

Referring to FIG. 15, the display device 2000 may include a source driver 2110, a timing controller 2120, a gate driver 2130, and a display panel 2200.

The timing controller 2120 may include at least one IC or module. The timing controller 2120 may communicate with a plurality of source driver integrated circuits SDIC and a plurality of gate driver integrated circuits GDIC through a predefined interface.

The timing controller 2120 may generate control signals for controlling the timings of the source driver integrated circuits SDIC and the gate driver integrated circuits GDIC and may provide the control signals to the source driver integrated circuits SDIC and the gate driver integrated circuits GDIC.

The source driver 2110 may include the source driver integrated circuits SDIC. The source driver integrated circuits SDIC may be mounted on a circuit film such as a TCP, a COF, or an FPC. The source driver integrated circuits SDIC may be attached to the display panel 2200 in a TAB manner or mounted on a non-display region of the display panel 2200 in a COG manner.

The gate driver 2130 may include the gate driver integrated circuits GDIC. The gate driver integrated circuits GDIC may be mounted on a circuit film. The gate driver integrated circuits GDIC may be attached to the display panel 2200 in a TAB manner or mounted on the non-display region of the display panel 2200 in a COG manner. Alternatively, the gate driver 2130 may be directly formed on a lower substrate of the display panel 2200 in a gate-driver in panel (GIP) manner. The gate driver 2130 may be formed in the non-display region outside a pixel array, in which pixels are formed, in the display panel 2200 and may be formed using the same TFT process as the pixels.

Each of the source driver integrated circuits SDIC may drive a source line according to a coarse precharge-fine driving method, as described above with reference to FIGS. 1 to 13, thereby minimizing an increase in circuit size, increasing the load charge rate of the display panel 2200, and reducing a settling time taken for the source line to be charged to a pixel voltage.

In an embodiment, each of a plurality of source driver ICs may include a gamma generator, e.g., the first gamma generator GG1 and the second gamma generator GG2 in FIG. 2. To reduce a variation in grayscale voltages generated by the source driver ICs, a reference voltage (or a tap voltage) that serves as a reference among a plurality of grayscale voltage may be provided in common to the source driver ICs.

In an embodiment, a plurality of reference voltages may be generated by a separate power management IC (PMIC) and provided to the source driver ICs or may be generated by one of the source driver ICs and provided to the other source driver ICs.

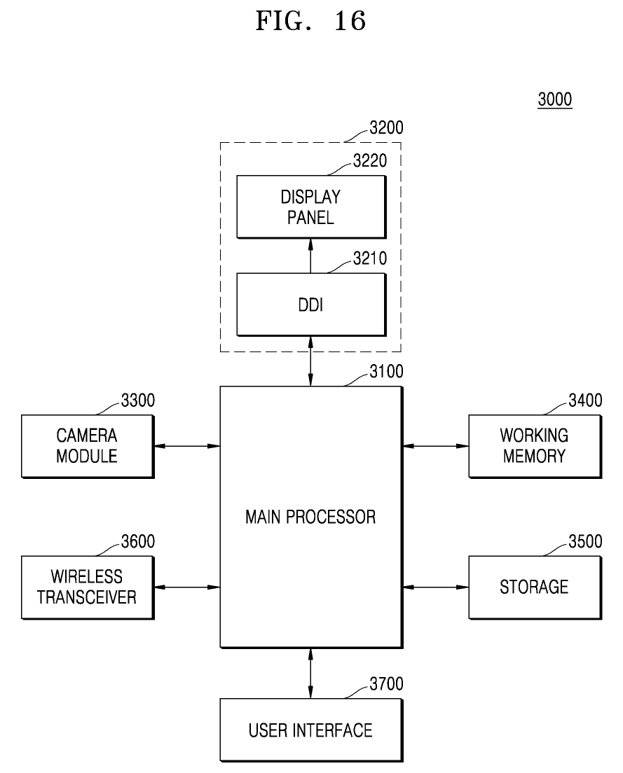

FIG. 16 illustrates an electronic device including a display device, according to an embodiment. An electronic device 3000 of FIG. 16 may correspond to a portable terminal.

Referring to FIG. 16, the electronic device 3000 may include a main processor 3100 (e.g., an application processor), a display device 3200, a camera module 3300, a working memory 3400, a storage 3500, a wireless transceiver 3600, and a user interface 3700.

The main processor 3100 may be implemented as a system-on-chip (SoC) that generally controls operations of the electronic device 3000 and drives an application program, an operating system, and/or the like. The main processor 3100 may provide image data provided from the camera module 3300 or image data stored in the storage 3500 to the display device 3200. The main processor 3100 may store image data provided from the camera module 3300 in the storage 3500.

The display device 3200 may include a display driver circuit (DDI) 3210 and a display panel 3220. The display driver circuit 100 described with reference to FIG. 1 may be applied to the display driver circuit 3210. A source driver of the display driver circuit 3210 may drive a source line according to a coarse precharge-fine driving method, as described above with reference to FIGS. 1 to 13, thereby minimizing an increase in circuit size, increasing the load charge rate of the display panel 3220, and reducing a settling time taken for the source line to be charged to a pixel voltage.

The camera module 3300 may include at least one image sensor. The camera module 3300 may capture an external object, generate image data, and provide the image data to the main processor 3100.

The working memory 3400 may include volatile memory, such as dynamic random access memory (DRAM) or static RAM (SRAM), or resistive-type non-volatile memory, such as ferroelectric RAM (FeRAM), resistive RAM (RRAM), or phase-change RAM (PRAM). The working memory 3400 may store programs and/or data, which the main processor 3100 processes or executes.

The storage 3500 may include a non-volatile memory device, such as a NAND flash memory device or a resistive-type memory device. For example, the storage 3500 may be provided as a memory card, such as a multimedia card (MMC), an embedded MMC (eMMC), a secure digital (SD) card, or a micro SD card. The storage 3500 may store image data provided from the camera module 3300 or image data received through the wireless transceiver 3600.

The wireless transceiver 3600 may include a transceiver, a modem, and an antenna. The wireless transceiver 3600 may receive data from an external device or transmit data to the external device through wireless communication.

The user interface 3700 may include various devices, such as a keyboard, a curtain key panel, a touch panel, a fingerprint sensor, and a microphone, which may receive a user input. The user interface 3700 may receive a user input and provide a signal corresponding to the user input to the main processor 3100.

While the inventive concept has been particularly shown and described with reference to embodiments thereof, it will be understood that various changes in form and details may be made therein without departing from the spirit and scope of the following claims.

What is claimed is:

1. A source driver comprising a plurality of driving channels, each configured to receive pixel data, generate an image signal based on the pixel data, and provide the image signal to a source line among a plurality of source lines of a display panel,
wherein each of the plurality of driving channels includes:
an output buffer circuit including a first output buffer and a second output buffer;
a decoder circuit including a first decoder configured to generate a first grayscale voltage based on N bits of the pixel data and a second decoder configured to generate a second grayscale voltage based on M bits of the pixel data, where M and N are natural numbers equal to or greater than 2, and M is greater than N;
an input switch circuit configured to provide one of the first grayscale voltage and the second grayscale voltage to the first output buffer and the other one of the first grayscale voltage and the second grayscale voltage to the second output buffer; and
an output switch circuit configured to output, as the image signal, one of a first output signal of the first output buffer and a second output signal of the second output buffer to the source line of the display panel.

2. The source driver of claim 1, wherein the first decoder is configured to receive 2^{N} grayscale voltages and select one of the 2^{N} grayscale voltages as the first grayscale voltage based on the N bits of the pixel data, and the second decoder is configured to receive 2^{M} grayscale voltages and select one of the 2^{M} grayscale voltages as the second grayscale voltage based on the M bits of the pixel data.

3. The source driver of claim 1, wherein the decoder circuit is further configured to generate a plurality of first grayscale voltages and a plurality of second grayscale voltages, each of the plurality of first grayscale voltages and each of the plurality of second grayscale voltages are generated based on corresponding pixel data corresponding to a column of the display panel, and the first output buffer and the second output buffer are alternately precharged based on the plurality of first grayscale voltages and configured to alternately drive the source line based on the plurality of second grayscale voltages.

4. The source driver of claim 1, wherein the N bits of the pixel data corresponds to upper N bits of the M bits of the pixel data.

5. The source driver of claim 1, further configured such that: in an n-th horizontal period, where n is a natural number, the first output buffer is precharged based on the first grayscale voltage received from the first decoder, and the second output buffer is configured to generate the second output signal based on the second grayscale voltage received from the second decoder and output the second output signal to the source line, and the first grayscale voltage is generated based on N bits among M bits of (n+1)-th pixel data corresponding to an (n+1)-th row of the display panel, and the second grayscale voltage is generated based on n-th pixel data corresponding to an n-th row of the display panel.

6. The source driver of claim 5, further configured such that, in an (n+1)-th horizontal period, the second output buffer is precharged based on a third grayscale voltage received from the first decoder, and the first output buffer is configured to generate the first output signal based on a fourth grayscale voltage received from the second decoder and output the first output signal to the source line, the third grayscale voltage is generated based on N bits among M bits of (n+2)-th pixel data corresponding to an (n+2)-th row of the display panel, and the fourth grayscale voltage is generated based on the (n+1)-th pixel data corresponding to the (n+1)-th row of the display panel.

7. The source driver of claim 6, wherein, when a difference between a data value of the (n+1)-th pixel data and a data value of the n-th pixel data is less than a threshold value, the first decoder and the first output buffer are disabled in the n-th horizontal period, and the second output buffer is configured to generate the second output signal based on the second grayscale voltage received from the second decoder and output the second output signal to the source line in the (n+1)-th horizontal period.

8. The source driver of claim 6, wherein the first output buffer is further configured to generate a first pre-emphasis output signal based on the first grayscale voltage received from the first decoder in a first sub-period of the (n+1)-th horizontal period and generate the first output signal based on the second grayscale voltage received from the second decoder in a second sub-period of the (n+1)-th horizontal period, the second sub-period following the first sub-period.

9. The source driver of claim 8, wherein the first pre-emphasis output signal has a voltage level greater than the second grayscale voltage.

10. The source driver of claim 1, wherein the input switch circuit includes:
a first input switch connected between a first output terminal of the first decoder and a first input terminal of the first output buffer;
a second input switch connected between a second output terminal of the second decoder and the first input terminal of the first output buffer;
a third input switch connected between the second output terminal of the second decoder and a second input terminal of the second output buffer; and
a fourth input switch connected between the first output terminal of the first decoder and the second input terminal of the second output buffer,
the output switch circuit includes:
a first output switch connected between a first output terminal of the first output buffer and an output pad; and
a second output switch connected between a second output terminal of the second output buffer and the output pad, and
the first input switch, the second input switch, the third input switch, the fourth input switch, the first output switch, and the second output switch operate in response to corresponding switching control signals.

11. An operating method of a source driver, the operating method comprising:
precharging a first output buffer based on an (n+1)-th coarse grayscale voltage output from a first decoder in an n-th horizontal period, where "n" is a natural number;
outputting, by a second output buffer, a first output voltage to a source line of a display panel in the n-th horizontal period, the first output voltage being generated based on an n-th fine grayscale voltage output from a second decoder;
outputting, by the first output buffer, a second output voltage to the source line in an (n+1)-th horizontal period, the second output voltage being generated based on an (n+1)-th fine grayscale voltage output from the second decoder; and
precharging the second output buffer based on an (n+2)-th coarse grayscale voltage in the (n+1)-th horizontal period, the (n+2)-th coarse grayscale voltage being received from the first decoder,
wherein a resolution of the first decoder is lower than a resolution of the second decoder.

12. The operating method of claim 11, further comprising:
selecting, by the first decoder, one of 2^{N} grayscale voltages as the (n+1)-th coarse grayscale voltage based on N bits among M bits of (n+1)-th pixel data in the n-th horizontal period; and
selecting, by the second decoder, one of 2^{M} grayscale voltages as the n-th fine grayscale voltage based on M bits of n-th pixel data in the n-th horizontal period,
wherein the (n+1)-th pixel data corresponds to an (n+1)-th row of the display panel, and the n-th pixel data corresponds to an n-th row of the display panel.

13. The operating method of claim 11, further comprising
outputting, by the first output buffer, a first pre-emphasis output voltage to the source line based on the (n+1)-th coarse grayscale voltage received from the first decoder in the (n+1)-th horizontal period before the outputting of the second output voltage to the source line.

14. The operating method of claim 13, wherein the first pre-emphasis output voltage is higher than the second output voltage.

15. The operating method of claim 11, further comprising:
outputting, by the first output buffer, a third output voltage to the source line in first sub-period of the n-th horizontal period after the outputting of the first output voltage to the source line by the second output buffer, the third output voltage being generated based on the (n+1)-th coarse grayscale voltage received from the first decoder,
wherein a gate-off signal is applied to pixels in a selected row among a plurality of rows of the display panel in the first sub-period.

16. A display device comprising:
a display panel including a plurality of pixels at intersections of a plurality of gate lines and a plurality of source lines, each pixel of the plurality of pixels being connected to a corresponding gate line among the plurality of gate lines and to a corresponding source line among the plurality of source lines;
a gate driver connected to the plurality of gate lines and configured to provide one of gate-on voltage and gate-off voltage to each of the plurality of gate lines; and
a source driver connected to the plurality of source lines,
wherein the source driver includes
a plurality of driving channels, each of the plurality of driving channels configured to receive pixel data, and provide an image signal corresponding to the pixel data to a source line among the plurality of source lines, wherein each of the plurality of driving channels includes:
a decoder circuit including a first decoder configured to generate coarse grayscale voltages and a second decoder configured to generate fine grayscale voltages, each of the coarse grayscale voltages is generated from N bits of the corresponding pixel data, and each of the fine grayscale voltages is generated from M bits of the corresponding pixel data, where M and N are natural numbers equal to or greater than 2, and M is greater than N; and
an output buffer circuit including a first output buffer and a second output buffer, the first output buffer and the second output buffer configured to be alternately precharged based on the coarse grayscale voltages and being configured to alternately drive the source line based on the fine grayscale voltages.

17. The display device of claim 16, wherein the first decoder is further configured to receive 2^{N} grayscale voltages and select one of the 2^{N} grayscale voltages for generating each coarse grayscale voltage based on the N bits of the corresponding pixel data, and the second decoder is further configured to receive 2^{M} grayscale voltages and select one of the 2^{M} grayscale voltages for generating each fine grayscale voltage based on the M bits of the corresponding pixel data.

18. The display device of claim 17, further configured such that: in an n-th horizontal period, where "n" is a natural number, the first output buffer is precharged based on an (n+1)-th coarse grayscale voltage received from the first decoder, and the second output buffer is further configured to generate a first output signal based on an n-th fine grayscale voltage received from the second decoder and output the first output signal to the source line and, in an (n+1)-th horizontal period, the second output buffer is precharged based on an (n+2)-th coarse grayscale voltage received from the first decoder, and the first output buffer is further configured to generate a second output signal based on an (n+1)-th fine grayscale voltage and output the second output signal to the source line.

19. The display device of claim 18, wherein the first output buffer is further configured to
generate a third output signal based on the (n+1)-th coarse grayscale voltage received from the first decoder and output the third output signal to the source line in a first period of the (n+1)-th horizontal period, and
generate the second output signal based on the (n+1)-th fine grayscale voltage received from the second decoder in a second period of the (n+1)-th horizontal period, the second period following the first period.

20. The display device of claim 18, further configured such that, in a first sub-period of an n-th horizontal period, the first output buffer is precharged based on the coarse grayscale voltage received from the first decoder, and the second output buffer is configured to generate the second output signal based on the fine grayscale voltage received from the second decoder and output the second output signal to the source line, in a second sub-period of the n-th horizontal period, the second sub-period following the first sub-period, the first output buffer is configured to generate a first precharge output signal based on the coarse grayscale voltage received from the first decoder and output the first precharge output signal to the source line, and the second output buffer is disabled, and the gate driver is configured to provide gate-on voltage in the first sub-period of the n-th horizontal period to an n-th gate line and to provide gate-off voltage during the second sub-period of the n-th horizontal period to the n-th gate line.
